(19) United States
(12) Patent Application Publication
(10) Pub. No.: US 2008/0307894 A1
(43) Pub. Date: Dec. 18, 2008

(54) Method and Sensor System for Monitoring a Fluid Flow

(75) Inventors: Michael Nuber, Nimburg (DE); Ralf Mueller, Oberursel (DE); Ruediger Ballas, Beusheim (DE)

Correspondence Address: MOORE & VAN ALLEN PLLC, P.O. BOX 13706, Research Triangle Park, NC, 27709, US

(73) Assignee: TECHNISCHE UNIVERSITAT, DARMSTADT (DE)

(21) Appl. No.: 11/914,663

(22) PCT Filed: May 10, 2006
(86) PCT No.: PCT/EP2006/004395

§ 371 Date: Jul. 11, 2008

(30) Foreign Application Priority Data
May 19, 2005 (DE) 10 2005 023 115.2

(51) Int. Cl. G01F 1/32

(52) U.S. Cl. 73/861.24

(57) ABSTRACT

In a method for monitoring fluid flow sensing a first sensed variable such as the differential pressure of the fluid flow as at least an indirect function of the fluid flow to be sensed and a second sensed variable such as the vortex shedding frequency at a bluff body located in the flow as at least an indirect function of the fluid flow and different from the first sensed variable is detected and/or determined; the first and second sensed variable are simultaneously detected and/or determined on the basis of one and the same basic physical sensing principle; and the first and second sensed variable are compared to each other.

The invention relates to a method of monitoring fluid flow sensing and to a sensor system for fluid flow sensing, said sensor system being provided with a watchdog function.

Market research has identified a major demand by users of flow sensors in the field of process engineering sensing for smart sensors, i.e. sensors having a watchdog function so that sensor disturbances caused by deposits, gas or liquid inclusions or foreign objects within the sensing loop, ageing, internal faults of the sensor (electronics failures, and the like), environmental effects, etc can be detected and eliminated, where possible.

It is known in closed loop control of chiller circuits and/or gas feeder systems or the like to make use of sensorics for sensing such process variables as flow, whose functioning can be watchdogged by comparing the actual condition of the process variable to a comparable process situation taken from the part with the aid of the process history. When there is a marked contrast in the results of the comparison, a malfunction is to be assumed. This known method necessitates precise knowledge of the process to be sensed as well as the wanted results as dictated not only by the sensor-specific properties but mainly also by to what extent the sensor is influenced by the ambient conditions of the process. Monitoring sensors on the basis of process history values for comparison is described in the German paper authored by Johannes Prock as published in the technical magazine devoted to automation systems “atp”, issue No. 5/2003 concerning watchdog systems, their limits and attendant monitoring, citing level sensing systems as an example. In this known watchdog approach its dependency on the environment of the process is a drawback because any change in the process characteristic, for example installing new apparatus in the field of a different kind, such as valves, renders the original comparison values taken from the process history useless for monitoring. Test runs are needed to obtain wanted comparison values for sensor monitoring as tweaked to the change in the response of the processing system. Similar problems materialize when new sensorics are to be incorporated in a time-proven, unchanged process. Because of the individual nature and manifold aspects in flow processing the monitoring system of the new sensor needs to be adapted to the circumstances of each process involved.

It is furthermore known to watchdog the sensor via its electronic components with the emphasis on monitoring how the sensing signals are processed electronically. Unfortunately, in monitoring the electronics, disturbances or errors as may occur in direct manual sampling of the physical sensing parameter as a function of the process variable—i.e. having nothing to do with the electronics—cannot be detected. Disturbances of this kind are usually eliminated by preventive action requiring the sensorics to be checked visually by intricated servicing. In this situation, the sensitivity of the sensorics to disturbances, which is incalculable, dictates how often servicing is to be performed.

It is the object of the invention to provide a method of monitoring fluid flow sensing and to a sensor system for fluid flow sensing, said sensor system being provided with a watchdog function which overcomes the drawbacks of prior art in providing in particular a watchdog mechanism for the sensing technique and the sensorics which works independently of the process involved in enhancing reliable diagnosis whilst reducing the need for servicing.

This object is achieved by the features of claim 1 and claim 12 respectively.

As it reads from these claims a method and a sensor system for monitoring fluid flow sensing is proposed wherein a first sensible variable such as the differential pressure of the fluid flow as at least an indirect function of the fluid flow to be sensed and a second sensible variable such as the vortex shedding frequency at an obstacle or a bluff body located in the flow as at least an indirect function of the fluid flow and different from the first sensible variable is detected and/or determined, the first and second sensible variable being simultaneously detected and/or determined by means of one and the same basic physical sensing principle and the first and second sensible variable are compared to each other.

The basic physical sensing principle can be performed capacitively inductively or resistively.

It shall be clear, that both sensible variables are directly proportional or directly linked to the fluid flow to be sensed. Both sensible variables represent the fluid flow or the fluid rate, however, both variables comprise different physical units as a frequence or speed, and both different sensible variables are measured by on and the same physical sensing principle.

The sensor system in accordance with the invention for fluid flow sensing comprises a basic sensing means for simultaneously detecting and/or determining a first sensed variable such as the differential pressure of the fluid flow as at least an indirect function of the fluid flow to be sensed and a second sensed variable such as the vortex shedding frequency at an obstacle or a bluff body located in the flow as at least an indirect function of the fluid flow and different from the first sensed variable, the basic sensing means for detecting and/or determining both the first and second sensible variables working according to one and the same basic physical sensing principle, and a means connected to the basic sensing means for comparing the first and second sensible variables of the basic sensing means.

In accordance with the intention, sensing the flow is implemented by means of at least two different sensing techniques wherein at least two different sensed variables are sensed on the basis of the same physical sensing principle. For example, in accordance with the first sensing technique the differential pressure in the flow is sensed and in accordance with the second sensing technique the vortex or vortex shedding frequency is sensed at a bluff body arranged in the flow. Both sensings are engineered by one and the same physical sensing principle, for example with the aid of a piezoelectric sensor in thus providing a diversity redundant monitoring system for flow sensing.

It was discovered that the disturbances most frequently experienced due to deposits, gas or liquid inclusions, abrasion and the like detriment sensing, such as when sensing the differential pressure or vortex shedding frequency, to a differing extent and characteristically. This difference in response to the disturbances is now made use of to permit pin-pointing the cause of the trouble at the sensor. Since in accordance with the invention the differing sensing techniques are based on the same physical sensing principle the source rendering implementing sensing unsure can now be excluded or also assumed. A disturbance accounted for by the sensing principle employed can now be identified by comparing known data characterizing the disturbance specific to the sensor concerned to the actual values of both results obtained.

The invention makes it possible to substantially reduce the servicing demand, because now even disturbances in the structure of the sensor itself can be detected without having to interrupt the flow.

From the detected actual values of the first and second sensed variable as well as from the comparison values between the first and second sensed variable defective or non-defective functioning of the sensor system detecting and/or determining the first and second sensed variable can now be established.

To permit establishing defective or non-defective functioning in detecting and/or determining the first and second sensed variable, a comparator is provided in which the detected actual values of the first and second sensed variable as well as their comparison values are checked.

In one aspect of the invention an optional sensing means is provided for simultaneously detecting and/or determining the first sensed variable and the second sensed variable differing from the first sensed variable, this optional sensing means working on the basis of a physical optional sensing principle different to the basic sensing principle and the same for the first and second sensed variable. Where the basic sensing principle is based on piezoelectric sensing, then in accordance with the aspect of the invention the optional sensing principle is based on some other physical principle such as a capacitive, inductive or resistive principle.

Preferably the basic sensing means for sensing the first and second sensed variable at a bluff body to be included in the flow stream for generating vortices for sensing is positioned in the lee-area or the wake of the bluff body. For this purpose the basic sensing means needs to be designed to sense the differential pressure of the flow stream as a first sensed variable and a vortex shedding frequency as the second sensed variable. This is preferably achievable by a piezoelectric body, particularly having the shape of an ideal bluff body in the flow stream.

In accordance with this aspect, the optional sensing means is likewise positioned at the bluff body. Like the basic sensing means the optional sensing means senses the differential pressure as well as the vortex shedding frequency but by means of a different sensing principle.

Preferably the basic sensing means is formed by a piezoelectric basic sensor which may be formed by a stack of piezoelectric layers featuring in particular a morphous, bimorphous or multimorphous structure oriented by its basic surface orthogonal to the direction of flow.

In a preferred aspect the bluff body is made at least in part of piezoelectric material, preferably totally of piezoelectric material.

The optional sensing means may be formed by a capacitive, inductive or resistive sensor. For example, the optional sensing means may be a strain gauge applied to the piezoelectric material forming the bluff body.

In another preferred aspect of the invention an optional comparator is provided connected to the basic sensing means and the optional sensing means. The optional comparator is designed to compare the first and second sensed variable of each sensing means to each other and particularly to the wanted sensed characteristics of each sensing means as memorized. The optional comparator makes it possible to assign a detected error to the sensing principle for the disturbed first or second sensed variable. For example, where abrasion is the trouble, disturbances are more likely to be expected when sensing the vortex shedding frequency, because the abrasion changing the geometry of the bluff body greatly detriments the vortex forming in the wake of the bluff body, whereas the falsifying effect of abrasion is much less when sensing the differential pressure.

To perform the necessary comparisons an analyzer can be provided which is capable of detecting errors and disturbance variables from the actual and comparison values. The analyzer can be formed by conventional electronic components.

In still another aspect of the invention the sensor system is provided with a final control element, such as a piezoelectric actor, for repositioning the basic sensing means and/or the optional sensing means. The final control element has the task—for instance should error or disturbance variables be induced by abrasion or deposits at the sensing means concerned—of compensating error or disturbance variables by repositioning the sensing means concerned in each case. Should, for example, the piezoelectric sensor be subject to abrasion because of flow attrition, the final control element can be activated, particularly streamed so that the piezoelectric sensor is corrected by the degree of abrasion.

Preferably the final control element and the sensing means are combined in a single component, namely in a piezoelectric body capable of both detecting sensed variables by sampling shifts in the charge building up within the body and becoming deflected by activation with an electric voltage. In this arrangement the bluff body can also be formed in a further function union by the piezoelectric body.

In yet another aspect of the invention means for recalibrating the basic sensing means and/or the optional sensing means are provided. Recalibration is achievable, for example, by application of defined current strengths or activation by a defined electric voltage to simulate the volume flow rates as can be monitored by the optional sensing means and vice-versa.

Where irreparable disturbances and errors occur in sensing a defined sensed variable on the basis of a specific sensing principle the portion of the sensing means responsible for the trouble can be taken out of circuit.

Further advantages, properties and features of the invention will now be detained by the following description of preferred aspects of the invention.

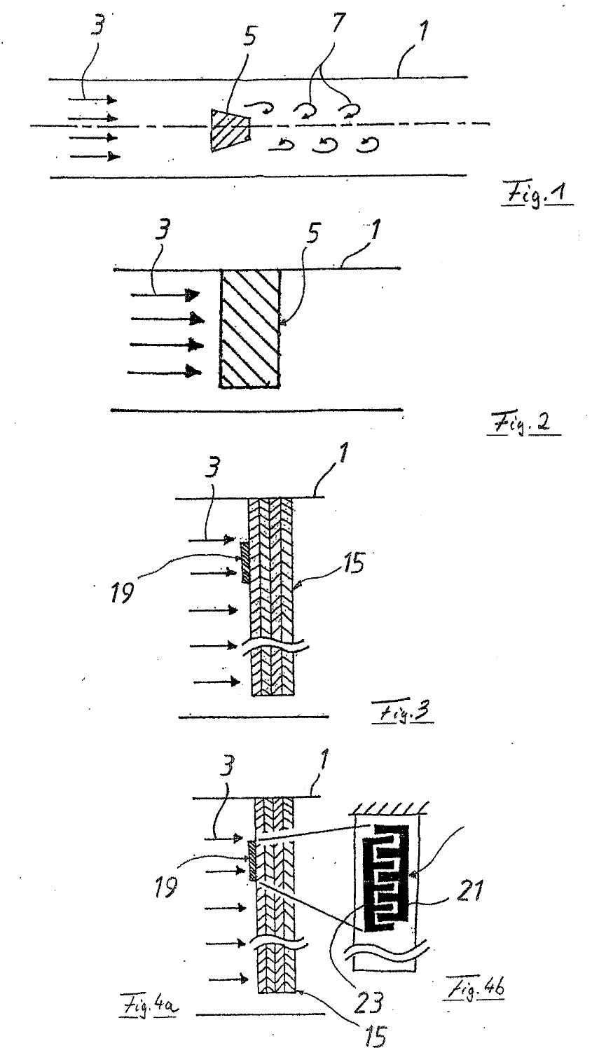

FIG. 1 is a diagrammatic top-down view of a conduit with a fluid flow in which a sensor in accordance with the invention is arranged;

FIG. 2 is a diagrammatic side view of the arrangement as shown in FIG. 1;

FIG. 3 is a diagrammatic side view of a sensor system in accordance with the invention in a first aspect;

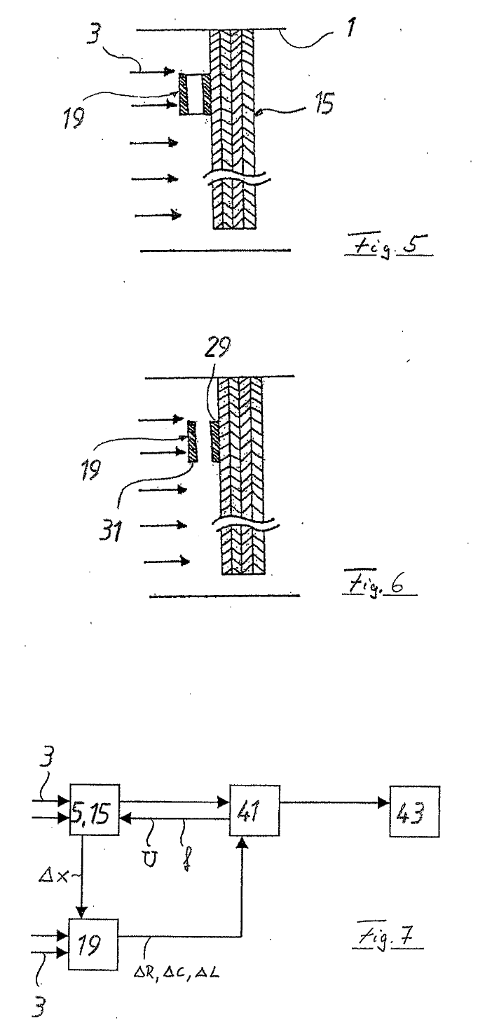

FIG. 4a is a diagrammatic side view of a sensor system in accordance with the invention in a second aspect

FIG. 4b is a detail view on a magnified scale of a capacitive optional sensing means integrated in the sensor system as shown in FIG. 4a;

FIG. 5 is a diagrammatic side view of a sensor system in accordance with the invention in a third aspect;

FIG. 6 is a diagrammatic side view of a sensor system in accordance with the invention in a fourth aspect; and

FIG. 7 is a block diagram for recalibration of a sensor system in accordance with the invention.

Shown in FIGS. 1 and 2 is a conduit identified by reference numeral 1, the arrows indicating a flow 3 streaming from left to right.

Jutting into the interior of the conduit is a sensor system in accordance with the invention featuring a basic sensor 5 of piezoelectric material. The basic sensor 5 is shaped as an obstacle or a bluff body suitable for configuring vortices 7—indicated by the circular arrows—in the wake being shedded from the basic sensor 5. In this arrangement the shape of the bluff body is selected such that forces detectable on shedding engage the sensor, generating electrical currents in the basic sensor 5 for detection.

One example of how a bluff body is shaped for an optimized sensing range reads from the German paper authored by Andreas Breier and Heinz Gatzmanga describing the parameter dependency of the flow frequency characteristic of vortex meters in the range of small Reynolds numbers, in the publication “Technisches Messen 62” Issue No. 1/1995 on page 16.

Due to the basic sensor 5 configured as a bluff body having a flow around it, the bluff body is deflected in the direction of flow by the differential pressure acting on streamed side of the basic sensor 5. In accordance with the piezoelectric sensing principle the charge is shifted within the piezoelectric material, in proportion to the differential pressure. It is this shift in charge that can then be detected by a signal processor (not shown). The detected differential pressure signal is substantially free of any frequency and changes practically linearly with the change in flow.

As an alternative, the differential pressure can be detected via a so-called compensation mode in which not the changes in the electrical charge in the piezoelectric material are detected but instead a voltage is applied to the piezoelectric material such that the basic sensor 5 is always in a defined position monitored by means of an integrated displacement sensing means 19. To always maintain the basic sensor 5 in the defined position despite the flow differences, the voltage needs to be raised or lowered which in turn is an indication of the velocity or differential pressure of the fluid flow.

In accordance with the invention a further sensing technique, other than that of sensing the differential pressure, is implied in the piezoelectric sensor 5 which piezoelectrically detects the frequency of the vortices 7 being shedded from the basic sensor 5 as a function of the corresponding excursion of the basic sensor 5. The signal representing the vortex shedding frequency jitters with a defined amplitude and frequency which can be easily filtered from the substantially constant differential pressure signal in likewise being proportional to the flow being sensed.

In other words, the sensor system in accordance with the invention offers two different sensing techniques, namely differential pressure sensing and vortex flow sensing with the aid of one and the same physical sensing principle, namely the piezoelectric principle.

Referring now to FIG. 3 there is illustrated a special aspect of the sensor system in accordance with the invention which, as compared to the system as shown in FIGS. 1 and 2, comprises a basic sensor 15 structured by a stack of piezoelectric layers in a morphous, bimorphous or multimorphous structure.

Referring still to FIG. 3 there is illustrated a sensor system comprising in addition to the piezoelectric sensor 15 an optional sensor 19 in the form of a strain gauge located at the upstream side of the piezoelectric basic sensor 15 forming the bluff body, this strain gauge too, detecting the essentially constant differential pressure and vortex shedding frequency.

Referring now to FIGS. 4a and 4b there is illustrated a further aspect of a sensor system in accordance with the invention which differs from that as shown in FIG. 3 in that a capacitive sensing principle used for the optional sensor 19 achieved by a capacitor having intermeshing electrodes 21 and 23 as shown in FIG. 4b. The change in capacitance due to the deflection of the basic sensor 15 permits detecting the differential pressure and the vortex shedding frequency.

Referring now to FIG. 5 there is illustrated a sensor system which differs from that as shown in FIGS. 3, 4a and 4b in that a plate-type capacitor is employed for the optional sensor 19.

Referring now to FIG. 6 there is illustrated a sensor system in accordance with the invention which differs from that as shown in FIGS. 3, 4a, 4b and 5 in that use is made of an inductive sensing principle for the optional sensor 19, achieved by an inner flat inductance 29 applied to the upstream side of the piezoelectric sensor 15 arranged spaced away from an external flat inductance 31, the spacing between the inductances being proportional to the differential pressure of the fluid flow and the vortex shedding frequency to be sensed.

With the aid of the optional sensor 19 signals sensing the differential pressure and the vortex shedding frequency are detected, resulting in a double diversity redundance for flow sensing. By comparing the piezoelectric sensed variables, disturbances can now be detected which are specific to the sensor system involved, i.e. errors can now be detected to which differential pressure and vortex shedding frequency sensing differingly responds. Now, by using the additional sensing principle which likewise senses the differential pressure and vortex shedding frequency, detecting whether an error specific to the sensing principle concerned has occurred is directly possible.

In other words, the invention renders the sensors smart by providing self-diagnosis.

In addition, the sensor system in accordance with the invention can now perform recalibration of the individual sensor parts by itself without having to be removed for this purpose or halting the flow process.

Referring now to FIG. 7 there is illustrated a recalibration method in accordance with the invention by way of example in which an electronics assembly 41 is designed to apply a defined electrical voltage U to the piezoelectric sensor 5, 15 to simulate the differential pressure and a defined voltage frequency f to simulate the vortex shedding. The excursion Δx induced thereby is sensed by the optional sensor 19. The optional sensor 19 relays the sensed calibration variable, for example the change in resistance ΔR, the change in capacitance ΔC, the change in inductance ΔL to the electronics 41 for visualization on a display 43. Via the display 43 an operator can also check the applied voltage U and the frequency f.

If changes are needed because of the results of calibration as determined by the analyzer (not shown), a voltage is applied to the piezoelectric basic sensor 5, 15 to tweak it into the predefined calibrated standby condition as monitored by means of the optional sensor 15.

If errors are discovered which are irreparable and can be assigned to one of the four sensings, namely sensing the differential pressure by the piezoelectric sensor 5, 15, sensing the vortex shedding frequency by the piezoelectric sensor 5, 15, sensing the differential pressure by the optional sensor 19, sensing the vortex shedding frequency by the optional sensor 19, an analyzer (not shown) can cause the sensor part responsible for the irreparable error to be taken out of circuit and alert replacement of the sensor part when the system is next serviced.

It is understood that the features of the invention as disclosed in the above description, in the drawings and as claimed may be essential to achieving the invention both by themselves or in any combination.

1. A method for monitoring fluid flow sensing wherein:
a first sensible variable, such as the differential pressure of the fluid flow, as at least an indirect function of the fluid flow to be sensed and a second sensible variable, such as the vortex shedding frequency at an obstacle located in the flow, as at least an indirect function of the fluid flow and different from the first sensible variable are detected and/or determined,
the first and second sensible variable are simultaneously detected and/or determined by means of one and the same basic physical sensing principle and
the first and second sensible variable are compared to each other.

2. The method of claim 1, wherein from the detected actual values of the first and second sensible variable as well as from the comparison values a) defective or non-defective detection and/or determination of the first and second sensible variable is detected.

3. The method of claim 1, wherein the first and second sensible variables are detected and/or determined by a piezoelectric means.

4. The method of claim 1, wherein the first and second sensible variables are simultaneously detected and/or determined in addition to the basic sensing principle also by means of an additional sensing principle different to the basic sensing principle.

5. The method of claim 4, wherein the first and second sensible variables are detected and/or determined in accordance with the additional sensing principle capacitively, inductively or resistively.

6. The method of claim 4, wherein each first and second sensible variable of the optional sensing principle is compared to each first and second sensible variable of the basic sensing principle.

7. The method of claim 6, wherein the first and second sensible variables of each sensing principle are compared to the desired sensing values.

8. The method of claim 6, wherein establishing a defective or non-defective detection and/or determination of the first and/or second sensible variable is realized by comparing the sensible variables of each sensing principle and particularly to the characteristical data as wanted in sensing.

9. The method of claim 8, wherein a detected error is assigned to detecting and/or determining the first and second sensible variable by comparing the sensible variables of each sensing principle.

10. The method of claim 9, wherein a means for detecting and/or determining the first and second sensed variable identified faulty is recalibrated on the basis of the results of the comparison.

11. The method of claim 8, wherein when an irreparable error is detected, the defective detection and/or determination of the sensed variable is taken out of circuit.

12. A sensor system for fluid flow sensing comprising
a basic sensing means for simultaneously detecting and/or determining a first sensible variable such as the differential pressure of the fluid flow as at least an indirect function of the fluid flow to be sensible and a second sensible variable such as the vortex shedding frequency at an obstacle located in the flow as at least an indirect function of the fluid flow and different from the first sensible variable, the basic sensing means for detecting and/or determining both the first and second sensible variables working according to one and the same basic physical sensing principle, and
a means connected to the basic sensing means for comparing the first and second sensed variable of the basic sensing means.

13. The sensor system of claim 12, wherein the basic sensing means is positioned at an obstacle body to be arranged in the flow for generating vortices in the lee-area of the obstacle body for sensing in detecting the differential pressure in the flow as well as a vortex shedding frequency at the obstacle body.

14. The sensor system of claim 12, wherein an additional sensing means is provided for simultaneously detecting and/or determining the first sensible variable and the second sensible variable differing from the first sensed variable, this additional sensing means working on the basis of a physical additional sensing principle different to the basic sensing principle and the same for the first and second sensed variable.

15. The sensor system of claim 14, wherein the additional sensing means is positioned at the obstacle body.

16. The sensor system of claim 12, wherein the basic sensing means is formed by a piezoelectric, capacitive or inductive basic sensor.

17. The sensor system of claim 16, wherein the piezoelectric basic sensor is formed by a stack of piezoelectric layers featuring in particular a morphous, bimorphous or multimorphous structure.

18. The sensor system of claim 13, wherein the obstacle body is made at least in part of piezoelectric material, preferably totally of piezoelectric material for generating vortices for sensing in the wake of the obstacle body.

19. The sensor system of claim 14, wherein the additional sensing means is formed by a capacitive, inductive or resistive sensor.

20. The sensor system of claim 14, wherein the additional sensor is a strain gauge.

21. The sensor system of claim 13, wherein connected to the basic sensing means and additional sensing means is an additional comparator which compares the sensible variables of each sensing means to each other and particularly to the memorized wanted sensed characteristics of basic sensing means and additional sensing means.

22. The sensor system of claim 12, wherein an analyzer for establishing error or disturbance variables due to the sensor being subject to abrasion in flow or deposits, etc is connected to the comparator and/or additional comparator.

23. The sensor system of claim 12, comprising a final control element, such as a piezoelectric actor, for repositioning the basic sensing means and/or the additional sensing means.

24. The sensor system of claim 23, wherein the final control element and basic sensing means and preferably a obstacle body for generating vortices for sensing in the lee-area of the obstacle body are achieved by a function union in a single component made particularly of piezoelectric material.

25. The sensor system of claim 22, wherein the analyzer comprises a means for recalibrating the basic sensing means and/or the additional sensing means said recalibrating means being connected to the final control element.

26. The sensor system of claim 12, wherein at least part of the each sensing means detecting and/or determining the first and second sensed variable can be taken out of circuit as activated particularly by the analyzer as soon as the analyzer identifies an irreparable error or disturbance variable and having assigned it to the part of the sensing means concerned.
